(19) United States
(12) Patent Application Publication
(10) Pub. No.: US 2026/0367227 A1
(43) Pub. Date: Nov. 19, 2026

(54) RECEIVING AND PROCESSING APPARATUS, RECEIVING AND PROCESSING CHIP, LiDAR, AND CONTROL METHOD THEREOF

(71) Applicant: SUTENG INNOVATION TECHNOLOGY CO., LTD., Shenzhen (CN)

(72) Inventor: Changsheng GONG, Shenzhen (CN)

(73) Assignee: SUTENG INNOVATION TECHNOLOGY CO., LTD., Shenzhen (CN)

(21) Appl. No.: 19/661,563

(22) Filed: Apr. 28, 2026

(30) Foreign Application Priority Data
May 13, 2025 (CN) 202510617391.X

(51) Int. Cl. G01S 7/481; G01S 7/486

(52) U.S. Cl. CPC G01S 7/4817; G01S 7/486

(57) ABSTRACT

This application provides a receiving and processing apparatus, a receiving and processing chip, a LiDAR, and a control method thereof. The receiving and processing apparatus comprises at least two groups of parameter registers, a counting module, and a switching control module. By configuring multiple groups of parameter registers in the receiving and processing apparatus of the LiDAR, each group of parameter registers stores configuration parameters corresponding to different detection angle ranges. The receiving and processing apparatus determines the current detection angle based on preset cyclic rules and counting results of scanning parameters, and then configures the LiDAR using the configuration parameters corresponding to that detection angle.

### CROSS-REFERENCE TO RELATED APPLICATION

The present application claims the benefit of priority to Chinese Patent Application No. 202510617391.X, filed on May 13, 2025, which is hereby incorporated by reference in its entirety.

### TECHNICAL FIELD

This application belongs to the field of radar technology and particularly relates to a receiving and processing apparatus, a receiving and processing chip, a LiDAR, and a control method thereof.

### BACKGROUND

A LiDAR is a radar system that uses emitted laser beams to detect information such as the position and velocity of targets. In addition to detecting the distance of objects, it can also detect the reflectance of objects used for target identification.

In practical applications, different detection fields of view may experience different optical factors such as transmittance, leading to performance discrepancies at different detection angles, which may in turn affect the accuracy of detection results. Moreover, different application scenarios also have different detection requirements.

How to reduce performance discrepancies caused by optical factors such as transmittance differences, improve the detection accuracy of a LiDAR, and at the same time meet the detection requirements of different application scenarios are pressing problems that need to be resolved.

### SUMMARY

Embodiments of the present application provide a receiving and processing apparatus, a LiDAR control method, and a LiDAR capable of reducing performance discrepancies caused by optical factors such as transmittance differences, improving the accuracy of LiDAR detection results, and switching corresponding parameters for detection based on application scenarios to meet different detection requirements of different application scenarios.

In a first aspect, an embodiment of the present application provides a receiving and processing apparatus, comprising:
at least two groups of parameter registers, wherein different groups of parameter registers are configured to store configuration parameters corresponding to different detection angle ranges;
a counting module, configured to count scanning parameters based on scanning information from a radar system to obtain a count result of the scanning parameters; and
a switching control module, respectively connected to the parameter registers and the counting module, configured to determine a current detection angle of the LiDAR based on the count result of the scanning parameters and a preset cyclic rule, determine a parameter register group corresponding to the detection angle range to which the current detection angle belongs as a target parameter register group, and switch the configuration parameters of the LiDAR to the configuration parameters stored in the target parameter register group; or configured to switch the configuration parameters of the LiDAR to configuration parameters corresponding to a first parameter configuration instruction based on the first parameter configuration instruction, wherein the first parameter configuration instruction is generated by a control module based on a current application scenario of the LiDAR.

In one implementation of the first aspect, the parameter register group is further configured to store configuration parameters corresponding to different scanning frames, the counting module comprises a scanning frame counting unit configured to count the number of scanning frames to obtain a count result of scanning frames; correspondingly, the switching control module is further configured to determine a current frame count based on the count result of the scanning frames output by the scanning frame counting unit and the preset cyclic rule, and determine the target parameter register group based on the current frame count.

In one implementation of the first aspect, the parameter register group is further configured to store configuration parameters corresponding to a target detection region, the counting module comprises a scanning column counting unit configured to count the number of scanning columns to obtain a count result of scanning columns; correspondingly, the switching control module is further configured to: if it is determined based on the count result of scanning columns that the current column is a scanning column of the target detection region, determine the parameter register group corresponding to the target detection region as the target parameter register group.

In one implementation of the first aspect, the receiving and processing apparatus further comprises: a communication interface, configured to connect to a control module of the LiDAR and to receive a first parameter configuration instruction output by the control module.

In a second aspect, an embodiment of the present application provides a LiDAR, comprising the receiving and processing apparatus according to the first aspect or any implementation of the first aspect, and a control module connected to the receiving and processing apparatus; the control module is configured to output a first parameter configuration instruction to the receiving and processing apparatus based on a current scanning scenario; the receiving and processing apparatus comprises at least two groups of parameter registers, wherein different groups of parameter registers are configured to store configuration parameters corresponding to different scanning scenarios, and the receiving and processing apparatus is configured to determine a target parameter register group based on the first parameter configuration instruction and switch the configuration parameters of the LiDAR to the configuration parameters stored in the target parameter register group.

In one implementation of the second aspect, the receiving and processing apparatus comprises a communication interface, the communication interface comprises a first communication interface and a second communication interface, and the receiving and processing apparatus further comprises a counting module; the second communication interface is configured to receive scanning information output by the control module; the counting module is configured to count scanning parameters based on the scanning information and output a count result of the scanning parameters; the receiving and processing apparatus is further configured to determine a target register group based on the count result of the scanning parameters output by the counting module and a preset cyclic rule.

In one implementation of the second aspect, the communication interface further comprises a third communication interface; the third communication interface is configured to receive a second parameter configuration instruction output by the control module; the receiving and processing apparatus is further configured to configure the parameter registers based on the second parameter configuration instruction.

In a third aspect, an embodiment of the present application provides a control method for a LiDAR, applied to the receiving and processing apparatus according to the first aspect or any implementation of the first aspect, wherein the receiving and processing apparatus comprises at least two groups of parameter registers, different groups of parameter registers storing configuration parameters corresponding to different detection angle ranges, the control method comprising: receiving scanning information and counting scanning parameters based on the scanning information to obtain a count result of the scanning parameters; determining a current detection angle based on the count result of the scanning parameters and a preset cyclic rule; determining the detection angle range to which the current detection angle belongs based on the current detection angle; determining a target parameter register group based on the detection angle range; and configuring the configuration parameters of the LiDAR as the configuration parameters stored in the target parameter register group.

In one implementation of the third aspect, the control method further comprises: receiving a first parameter configuration instruction; and determining the target parameter register group based on the first parameter configuration instruction.

In one implementation of the third aspect, the control method further comprises: receiving a second parameter configuration instruction; and configuring the parameter registers based on the second parameter configuration instruction.

In a fourth aspect, an embodiment of the present application provides a terminal device, the terminal device comprising a processor, a memory, and a computer program stored in the memory and executable by the processor, the processor implementing the method according to the third aspect or any optional implementation of the third aspect when executing the computer program.

In a fifth aspect, an embodiment of the present application provides a computer-readable storage medium storing a computer program, the computer program implementing the method according to the third aspect or any optional implementation of the third aspect when executed by a processor.

In a sixth aspect, an embodiment of the present application provides a computer program product, when the computer program product runs on a terminal device, causing the terminal device to execute the method according to the third aspect or any optional implementation of the third aspect.

In a seventh aspect, an embodiment of the present application provides a receiving and processing chip, comprising the receiving and processing apparatus according to the first aspect or any optional implementation of the first aspect.

The embodiments of the present application, compared to the prior art, provide the following beneficial effects: by configuring multiple groups of parameter registers in the receiving and processing apparatus of the LiDAR, wherein each group of parameter registers can store configuration parameters corresponding to different detection angle ranges, the receiving and processing apparatus can determine the current detection angle based on preset cyclic rules and counting results of scanning parameters, and then configure the LiDAR using the configuration parameters corresponding to that detection angle, enabling the LiDAR to operate with configuration parameters corresponding to the detection angles, thereby reducing performance discrepancies caused by optical factors such as transmittance differences and improving the accuracy of LiDAR detection results. At the same time, the receiving and processing apparatus can also switch the configuration parameters of the LiDAR to configuration parameters corresponding to the current scanning scenario, enabling the LiDAR to operate with configuration parameters corresponding to the current scanning scenario to meet the detection requirements of different application scenarios.

### BRIEF DESCRIPTION OF DRAWINGS

To illustrate the technical solutions in the embodiments of the present application more clearly, the drawings for use in the description of the embodiments or the prior art are briefly introduced below. Obviously, the drawings described below are only some embodiments of the present application. For those skilled in the art, other drawings can also be obtained based on these drawings without any creative effort.

FIG. 1 is a schematic diagram of an application scenario of a LiDAR system in accordance with an embodiment of the present application;

FIG. 2 is a structural schematic diagram of a LiDAR in accordance with an embodiment of the present application;

FIG. 3 is a structural schematic diagram of a receiving and processing apparatus;

FIG. 4 is a schematic diagram of a detection field of view in accordance with an embodiment of the present application;

FIG. 5 is a structural schematic diagram of another receiving and processing apparatus in accordance with an embodiment of the present application;

FIG. 6 is a structural schematic diagram of yet another receiving and processing apparatus in accordance with an embodiment of the present application;

FIG. 7 is a structural schematic diagram of a LiDAR in accordance with an embodiment of the present application;

FIG. 8 is a structural schematic diagram of another LiDAR in accordance with an embodiment of the present application;

FIG. 9 is a structural schematic diagram of yet another LiDAR in accordance with an embodiment of the present application;

FIG. 10 is a schematic flow diagram of a control method for a LiDAR in accordance with an embodiment of the present application;

FIG. 11 is a schematic flow diagram of another control method for a LiDAR in accordance with an embodiment of the present application;

FIG. 12 is a schematic flow diagram of yet another control method for a LiDAR in accordance with an embodiment of the present application;

FIG. 13 is a schematic flow diagram of yet another control method for a LiDAR in accordance with an embodiment of the present application;

FIG. 14 is a schematic interaction diagram of a parameter register group configuration process in a receiving and processing chip in accordance with an embodiment of the present application;

FIG. 15 is a structural schematic diagram of a terminal device in accordance with an embodiment of the present application; and

FIG. 16 is a structural schematic diagram of a computer-readable storage medium in accordance with an embodiment of the present application.

### DETAILED DESCRIPTION

In the following description, for purposes of explanation rather than limitation, specific details such as particular system structures and technologies are set forth in order to provide a thorough understanding of the embodiments of the present application. However, it will be apparent to those skilled in the art that the present application may be practiced in other embodiments without these specific details. In other instances, detailed descriptions of well-known systems, devices, circuits, and methods are omitted to avoid unnecessary detail that would obscure the description of the present application.

It should be understood that the term "and/or" as used in the specification and appended claims of the present application refers to any and all possible combinations of one or more of the associated listed items and includes such combinations. In addition, in the description of the specification and appended claims, the terms "first," "second," "third," and the like are used only to distinguish descriptions and shall not be understood to indicate or imply relative importance.

It should also be understood that references to "one embodiment" or "some embodiments" and the like in the specification of the present application mean that a specific feature, structure, or characteristic described in connection with the embodiment is included in one or more embodiments of the present application. Thus, the phrases "in one embodiment," "in some embodiments," "in other embodiments," "in yet other embodiments," and the like appearing in various places throughout this specification are not necessarily all referring to the same embodiment, but rather mean "one or more but not all embodiments," unless otherwise specifically emphasized. The terms "comprises," "includes," "has," and their variants all mean "includes but is not limited to," unless otherwise specifically emphasized.

A LiDAR is a radar system that uses emitted laser beams to detect information such as the position and velocity of targets. In addition to detecting the distance of objects, it can also detect the reflectance of objects used for target identification. The specific operating principle of a LiDAR is to emit a detection signal toward a target; the detection signal, upon reaching the target, is reflected by the target object to form echo data; the LiDAR receives the signal reflected back from the target (echo data) and then determines information about the target based on the echo data, such as target distance, position, height, velocity, attitude, shape, and reflectance, thereby achieving target detection, target tracking, and target identification. The reflectance of an object refers to the percentage of radiant energy reflected by the object to the total radiant energy of the incident signal. Different objects have different reflectances; the reflectance of an object is primarily determined by factors such as the surface characteristics of the object, the wavelength of the incident signal, and the angle of incidence.

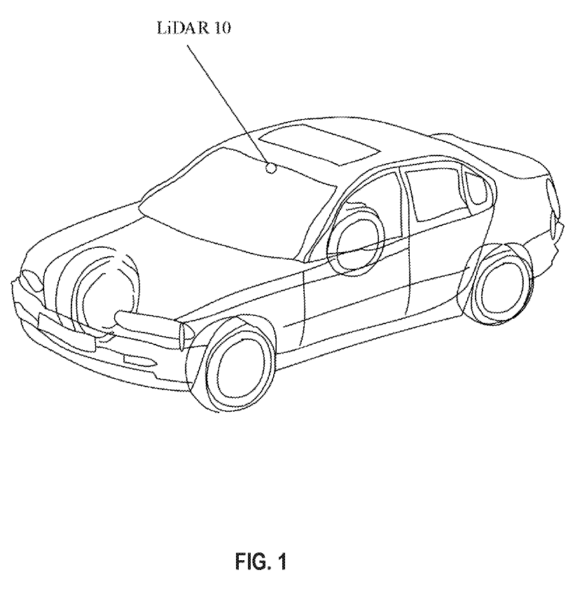

In one specific application scenario, FIG. 1 exemplarily shows a schematic diagram of an application scenario of a LiDAR system provided by embodiments of the present application. In this example, the LiDAR 10 may be installed on a vehicle, and thus is referred to as a vehicle-mounted LiDAR system. The LiDAR may also be installed on other mobile devices, such as mobile robots or ships. The present application places no restriction on the type of mobile device.

The LiDAR may be a mechanical LiDAR, a solid-state LiDAR, or a semi-solid-state LiDAR, among others. The present application places no restriction on this.

In the present application, the LiDAR may include a control module and a data processing module. The control module is configured to control the LiDAR to emit detection laser and to control the LiDAR to receive echo laser. The data processing module is configured to process the echo data received by the radar and to output corresponding detection data.

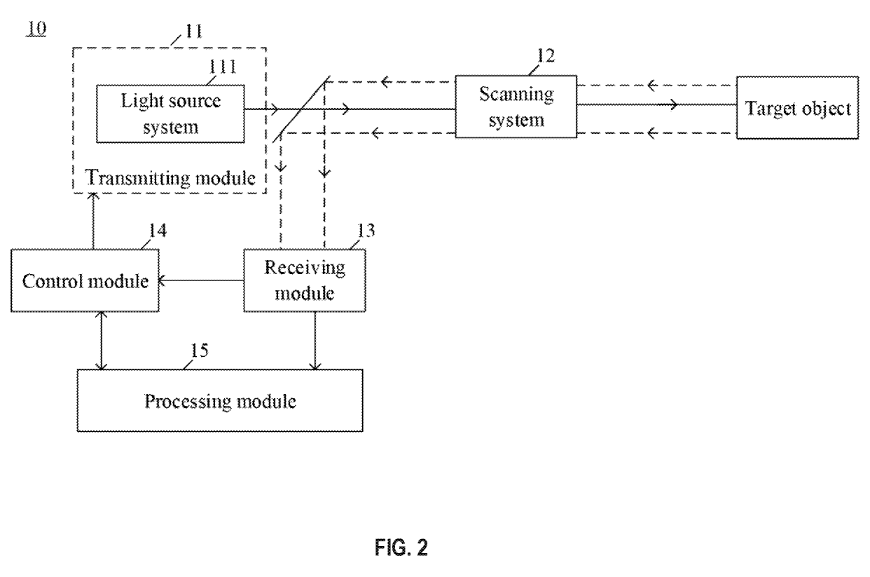

By way of example, refer to FIG. 2, which shows a structural schematic diagram of a LiDAR. As shown in FIG. 2, the LiDAR 10 typically comprises a transmitting module 11, a scanning system 12, a receiving module 13, a control module 14, and a receiving and processing module 15. The transmitting module 11 may include a light source system 111.

The light source system 111 is configured to generate the laser beam required for detection by the LiDAR 10. Specifically, the light source system 111 may include optical components such as a laser and a transmitting lens assembly. The scanning system 12 is configured to deflect the laser beam generated by the light source system 111 angularly, so that the laser beam can strike different positions at different moments. The scanning system 12 may be a mechanical scanning system (i.e., a rotating drive platform) or a semi-solid-state scanning system (i.e., a rotating mirror, an oscillating mirror, or a combination thereof). The present application places no restriction on the form of the scanning system.

It is understood that the LiDAR in the present application may also be a solid-state LiDAR, i.e., scanning is achieved by controlling light sources at different angles to emit light in sequence. After the laser beam emitted by the light source system reaches the target object and is reflected by the target object, the reflected light pulse is received by a receiving sensor in the receiving module 13, and then the echo signal is processed by an echo signal processing circuit to generate corresponding detection information.

The control module 14 is configured to control the LiDAR to emit detection laser and to control the LiDAR to receive echo laser. The receiving and processing module 15 is configured to process the echo data received by the radar and to output corresponding detection data.

In practical applications, due to the influence of factors such as the vignetting effect of the optical system, aberrations and chromatic aberration of optical elements, structural stray light, and the response characteristics of the detector, performance discrepancies exist at different detection angles (FOV).

Specifically, when the field-of-view angle increases, the propagation path of off-axis rays in the optical system changes. Due to the limited size of optical elements, some marginal rays may not pass through the entire system, resulting in the vignetting phenomenon. The vignetting phenomenon causes an uneven distribution of light intensity at different field-of-view positions on the imaging plane, manifested as a weakening of light intensity at the edges of the field of view relative to the central region, which in turn affects transmittance. At different field-of-view angles, the refraction and reflection of light in the optical system differ, leading to changes in aberrations. Aberrations prevent light from accurately focusing on the image plane, instead forming a circle of confusion, which affects transmittance.

Structural stray light also affects transmittance. Structural components such as lens barrels and brackets in the optical system may reflect light. When the field-of-view angle is large, light is more likely to strike these structural components, producing stray light. Such stray light undergoes multiple reflections inside the optical system and may ultimately enter the imaging optical path, interfering with the normal beam. Due to factors such as surface roughness of optical elements and internal impurities or inhomogeneities, light may be scattered. At different field-of-view angles, the interaction of light with these scattering sources differs, and the distribution and intensity of scattered light also varies. Scattered light redistributes light energy in space, causing part of the light to deviate from its original propagation direction, thereby affecting transmittance.

In addition, the detector may have varying response characteristics to light incident at different angles. At large field-of-view angles, light strikes the detector at larger oblique angles, and the response uniformity and other performance characteristics of the detector may change, causing the detector to have different conversion efficiencies for optical signals at different field-of-view angles, thereby affecting the ultimately measured transmittance.

It can thus be seen that different detection fields of view, due to the influence of different optical factors such as transmittance, exhibit performance discrepancies at different detection angles, which may in turn affect detection results.

Moreover, in the use of LiDAR, different application scenarios also have different detection requirements.

Based on this, embodiments of the present application provide a receiving and processing apparatus, a LiDAR, and a radar control method. By configuring multiple groups of parameter registers in the receiving and processing apparatus of the LiDAR, wherein each group of parameter registers can store configuration parameters corresponding to different detection angle ranges, the receiving and processing apparatus can determine the current detection angle based on preset cyclic rules and counting results of scanning parameters, and then configure the LiDAR using the configuration parameters corresponding to that detection angle, enabling the LiDAR to operate with configuration parameters corresponding to the detection angles, thereby reducing performance discrepancies caused by optical factors such as transmittance differences and improving the accuracy of LiDAR detection results. At the same time, the receiving and processing apparatus can also switch the configuration parameters of the LiDAR to configuration parameters corresponding to the current scanning scenario, enabling the LiDAR to operate with configuration parameters corresponding to the current scanning scenario to meet the detection requirements of different application scenarios.

The receiving and processing apparatus, receiving and processing chip, LiDAR, and control method thereof provided by the embodiments of the present application will be described in detail below.

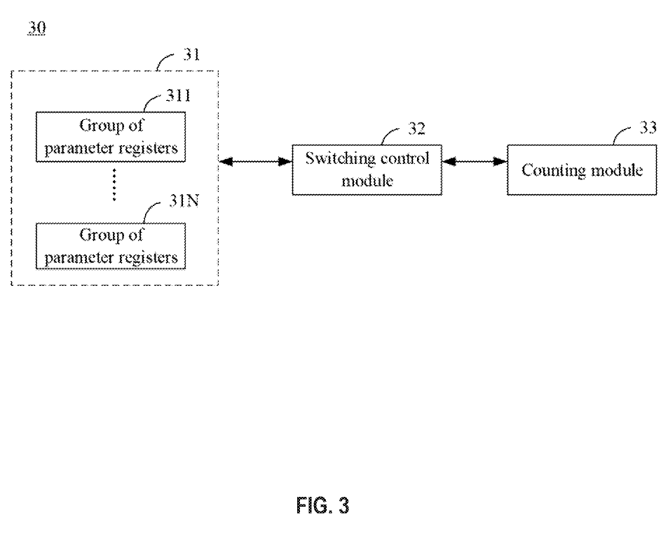

Refer to FIG. 3, which shows a structural schematic diagram of a receiving and processing apparatus 30 provided by an embodiment of the present application. It is understood that the receiving and processing apparatus 30 in FIG. 3 may correspond to the receiving and processing module 15 in FIG. 2. As shown in FIG. 3, the receiving and processing apparatus 30 may include at least two groups of parameter registers 31 (e.g., 311 to 31N in FIG. 3), a switching control module 32, and a counting module 33. N is a positive integer greater than or equal to 2.

The switching control module 32 is respectively connected to the plurality of groups of parameter registers 31 and the counting module 33.

In a specific application, the parameter registers 31 are configured to store configuration parameters of the LiDAR. The configuration parameters may include, but are not limited to, transmit power, transmit pulse width, transmit cycle, number of transmissions, number of combinations of receive photosensitive units, offset position of receive photosensitive units, analysis window duration of receive photosensitive units, and receive start time of receive photosensitive units.

In a specific application, the parameter registers control scanning parameters based on the configuration parameters stored in the LiDAR, i.e., by configuring the configuration parameters in the parameter registers, the operating parameters of the LiDAR can be set.

In a specific application, the receive photosensitive units described above may specifically refer to the photosensitive receiving devices in the receiving and processing module. The receive photosensitive units are configured to receive echo beams and output corresponding sampled data. The receive photosensitive units may specifically be photosensitive units in a receive photosensitive array. Specifically, the receive photosensitive units described above may be any one of a silicon photomultiplier (SiPM), an avalanche photodiode (APD), or a single-photon avalanche diode (SPAD). The present application places no restriction on this.

In a specific application, the configuration parameters stored in each group of parameter registers correspond to one detection angle range, i.e., each group of parameter registers corresponds to one detection angle range. It is understood that the configuration parameters stored in different groups of parameter registers may partially differ or partially be the same. The present application places no restriction on this.

In a specific application, the specific parameter values of the configuration parameters stored in each group of parameter registers may be set based on the detection requirements for different detection angle ranges, i.e., the radar system may set the configuration parameters stored in each parameter register group based on the detection requirements for different detection angle ranges, and may set the correspondence between detection angle ranges and parameter register group numbers (referred to as the first correspondence). Here, the configuration parameters for different detection angle ranges may be set based on the consistency requirements of the detection field of view.

In a specific application, detection angles with transmittance differences within a preset range may be grouped into one detection angle range. For detection angle ranges with different transmittances, configuration parameters suitable for that transmittance are set. For example, for detection angles with lower transmittance, higher transmit power is set, a larger number of receive unit combinations is set, the offset position of the receive units is set based on the light spot offset of the angle range with low transmittance, and an appropriate receive start time is set for that angle range based on time delay, thereby increasing the probability of capturing received signals, increasing signal strength, and improving the signal-to-noise ratio. For detection angles with higher transmittance, lower transmit power is set, a smaller number of receive unit combinations is set, and the offset position of the receive units is set based on the light spot offset of the angle range with high transmittance, thereby meeting detection requirements while reducing power consumption and system complexity. By adjusting the corresponding configuration parameters for different transmittances, the impact on the LiDAR detection results caused by uneven transmittance at different detection angles of the detection field of view can be reduced.

By way of example, the counting module 33 may be connected to the control module 14 of the radar system, and the counting module 33 can count scanning parameters based on the scanning information of the radar system.

It is understood that the control module 14 of the radar system, when controlling the scanning devices of the radar to perform scanning, can do so based on a preset scanning strategy. The scanning strategy refers to a specific scanning plan for the control module 14 to control the LiDAR to perform scanning, including for example the duration of each scanning cycle, the number of scanning frames, the number of scanning rows, the number of scanning columns, the number of scans within each scanning cycle, the transmission time of each scan, and so on. Therefore, the control module 14 of the radar system can determine the scanning information of the radar system, i.e., can determine the scanning parameters at the current moment. The scanning parameters include but are not limited to at least one of the number of scanning frames, the number of scanning rows, and the number of scanning columns.

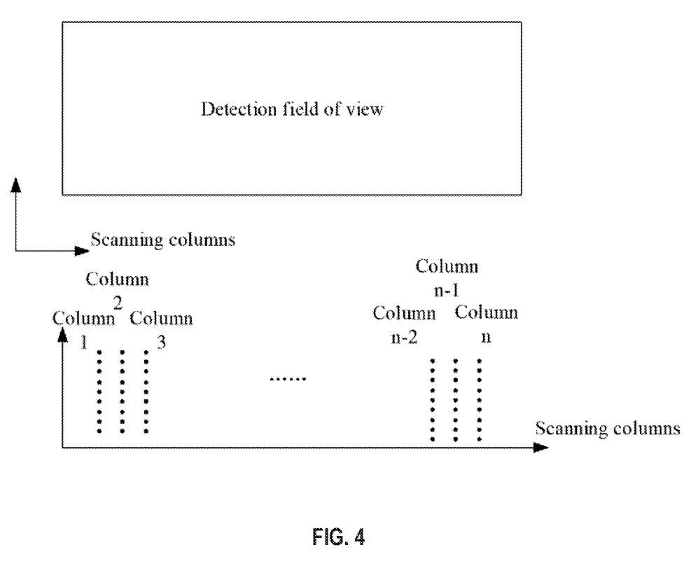

In a specific application, taking the detection field of view of the LiDAR as a plane as an example, as shown in the detection field of view in FIG. 4, the detection field of view can be viewed as a combination of scanning rows and scanning columns, wherein scanning rows are a series of point clouds in the horizontal direction of the detection field of view, and scanning columns are a series of point clouds in the vertical direction of the detection field of view. When the control module 14 of the radar system controls the scanning devices to perform scanning, it corresponds to the number of scanning rows and scanning columns in the detection field of view. Each column corresponds to a different horizontal detection field-of-view angle range, and each row corresponds to a different vertical detection field-of-view angle range.

In some implementations, each scanning column may correspond to different configuration parameters, for example, columns 1, 2, 3, 4, ..., n in FIG. 4 may correspond to different configuration parameters.

In some implementations, as shown in the detection field of view in FIG. 4, the edge detection region columns on the left and right sides (e.g., columns 1 to 3 and columns n-2 to n) may have lower optical transmittance compared to the center detection region columns (e.g., columns 3 to n-2). To minimize the impact of optical transmittance differences, the number of receive measurement times corresponding to the edge detection region columns may be set higher than that of the center detection region columns; alternatively, the transmit power corresponding to the edge detection region columns may be set higher than that of the center detection region columns. It is understood that n is a positive integer.

In a specific application, the counting module 33 described above may obtain the scanning information of the radar system from the control module 14, and then count the scanning parameters, such as the number of scanning frames, scanning columns, and/or scanning rows.

The switching control module 32 described above can determine the current detection angle of the LiDAR based on the count result of the scanning parameters counted by the counting module 33, and can further determine the parameter register group corresponding to the current detection field of view, i.e., determine the target parameter register group, and switch the configuration parameters of the radar system to the configuration parameters stored in the target parameter register group.

The switching control module 32 described above can determine the current detection angle and the detection angle range to which the current detection angle belongs based on the count result of the counting module 33 and the preset cyclic rule, and then determine the corresponding target parameter register group based on the first correspondence, i.e., determine the parameter register group number corresponding to the detection angle range and set that group of parameter registers as the target parameter register group.

In a specific application, the preset cyclic rule described above may be determined based on the scanning strategy described above, and may specifically refer to the number of scanning rows and scanning columns included in each frame when the LiDAR performs scanning. For example, if the scanning strategy sets each frame to include n rows of scanning rows and m columns of scanning columns, then it can be determined that every n scanning rows form one cycle, every m scanning columns form one cycle, and every n*m point clouds form one scanning frame cycle. Since the number of scanning rows and/or scanning columns corresponds to the detection angles in the detection field of view, based on the count result of the number of scanning rows and/or the preset cyclic rule, the detection angle corresponding to the count result of the number of scanning rows and/or scanning columns can be determined, and the target parameter register group can accordingly be identified.

In some implementations, the correspondence between frame count results and detection angle ranges may also be set. After obtaining the frame count result, the corresponding detection angle range can be directly determined, thereby determining the corresponding target parameter register group.

In addition, different scanning frames may also have different detection requirements; therefore, different scanning frames may also correspond to different configuration parameters. After determining the scanning frame count result, the parameter register group corresponding to that scanning frame can be determined based on the scanning frame count result, and the configuration parameters of the LiDAR can be switched to the parameters corresponding to that parameter register group. For example, different scanning frames may have different detection requirements in terms of transmit power, receive analysis window duration, receive photosensitive unit combinations, or one or more combinations thereof.

In a specific application, after the switching control module 32 has determined the target parameter register group, the radar system can be configured based on the configuration parameters stored in the target parameter register group. For example, the transmit power of the radar system's transmitting device is configured based on the transmit power stored in the target parameter register group; or the photosensitive units enabled in the receive photosensitive array of the receiving and processing chip are configured based on the number of receive photosensitive unit combinations stored in the target parameter register group.

In the embodiments of the present application, the switching control module 32 described above may also be configured to switch the configuration parameters of the LiDAR to configuration parameters corresponding to a first parameter configuration instruction based on the first parameter configuration instruction.

The first parameter configuration instruction is generated by the control module 14 based on the current application scenario of the LiDAR.

In a specific application, the control module 14 may be the main control chip of the LiDAR. The control module 14 can determine the current scanning scenario and output a first configuration parameter instruction based on the current scanning scenario.

In some embodiments, the parameter register groups of the receiving and processing apparatus described above may include parameter register groups for which parameters can be quickly configured. The switching control module can configure these quickly-configurable parameter registers based on the first configuration parameter, i.e., configure the configuration parameters stored in the parameter register groups to be the configuration parameters corresponding to the first configuration parameter. The first configuration parameter in the embodiments of the present application may be configuration parameters corresponding to the current application scenario of the LiDAR as generated by the control module.

By way of example, the control module can determine the configuration parameters corresponding to the current application scenario based on the detection distance of the LiDAR's current application scenario, for example, generating one set of corresponding configuration parameters for a long-range detection scenario and another set of corresponding configuration parameters for a short-range detection scenario.

As another example, the control module can determine the configuration parameters corresponding to the current application scenario based on the resolution requirements of the current application scenario, for example, setting one set of corresponding configuration parameters for application scenarios with high resolution requirements.

As yet another example, the control module determines different configuration parameters based on the number of obstacles in the current application scenario, for example, setting one set of configuration parameters corresponding to high resolution requirements for application scenarios with many obstacles, and another set of configuration parameters corresponding to low resolution requirements for application scenarios with fewer obstacles.

In some embodiments, the parameter register groups of the receiving and processing apparatus described above may include parameter register groups storing configuration parameters for different scanning scenarios. The first configuration parameter instruction carries the group number of the target parameter register group, i.e., the control module can determine the target parameter register group corresponding to the current scanning scenario and add the group number of that target parameter register group to the first configuration parameter instruction. For example, preset bit positions may be set as group number flag bits; the group number can be determined from the bit values of the preset bit positions. The switching control module 32 described above can determine the group number of the target parameter register by parsing the first configuration parameter instruction and reading the bit values of the preset bit positions, thereby identifying the target parameter register and reading the configuration parameters from the target parameter register to configure the LiDAR, thus meeting the requirement for detection based on different scanning scenarios.

From the above, it can be seen that the receiving and processing apparatus provided by the embodiments of the present application, by configuring multiple groups of parameter registers in the receiving and processing apparatus of the LiDAR, wherein each group of parameter registers can store configuration parameters corresponding to different detection angle ranges, enables the receiving and processing apparatus to determine the current detection angle based on preset cyclic rules and counting results of scanning parameters, and then configure the LiDAR using the configuration parameters corresponding to that detection angle, enabling the LiDAR to operate with configuration parameters corresponding to detection angles, thereby reducing performance discrepancies caused by optical factors such as transmittance differences and improving the accuracy of LiDAR detection results. At the same time, the receiving and processing apparatus can also switch the configuration parameters of the LiDAR to configuration parameters corresponding to the current scanning scenario, enabling the LiDAR to operate with configuration parameters corresponding to the current scanning scenario to meet the detection requirements of different application scenarios.

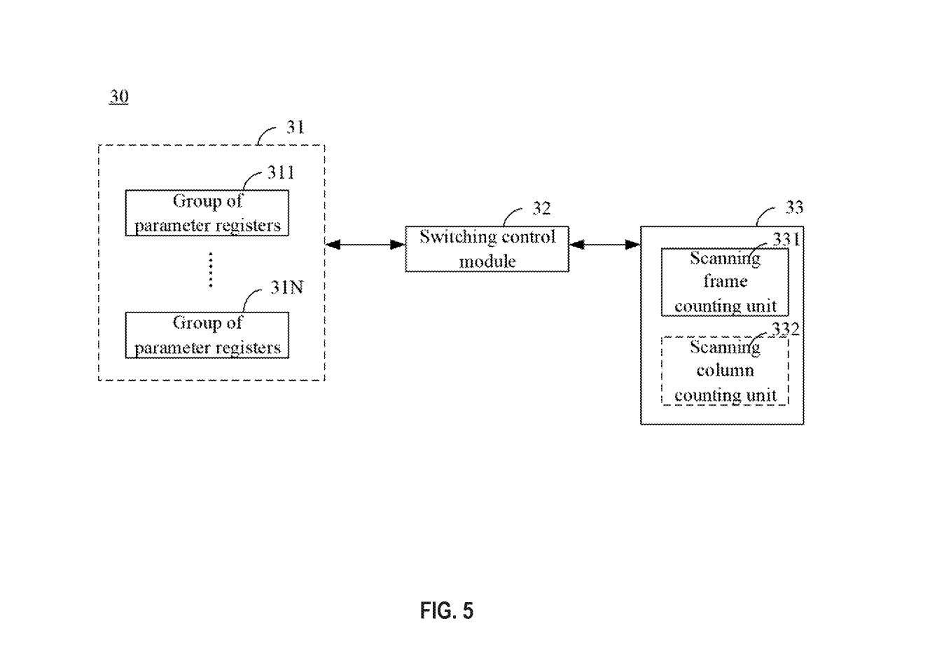

In one embodiment of the present application, refer to FIG. 5, which shows another receiving and processing apparatus provided by an embodiment of the present application. As shown in FIG. 5, in the embodiments of the present application, the counting module 33 described above may include a scanning frame counting unit 331.

The scanning frame counting unit 331 is connected to the switching control module 32 described above and is configured to count the number of scanning frames to obtain a count result of the scanning frames.

Correspondingly, the switching control module 32 described above is configured to determine the current frame count based on the count result of the scanning frames and the preset cyclic rule, and to determine the target parameter register group based on the current frame count.

To meet different detection requirements, different configuration parameters may be set for different scanning frames. For example, when using a rotating mirror for switching, different rotating mirror faces require different configuration parameters. Therefore, different configuration parameters may be configured for scanning frames corresponding to different rotating mirror faces to accommodate the measurement requirements of different scanning frames. As another example, when measuring different combined frames, such as one frame for measuring close-range objects and another frame for measuring long-range objects, the parameter register group also needs to be switched based on the scanning frame count result.

By way of example, different scanning angle ranges may be implemented based on different scanning rows or scanning columns for parameters, or may be implemented based on scanning devices. Specific scanning devices may include, but are not limited to, oscillating mirrors, rotating mirrors, tilting mirrors, and prisms. For example, different scanning angle ranges corresponding to different scan angles can be set based on different sub-scans of an oscillating mirror; or different scanning angle ranges can be set based on different scanning faces of a rotating mirror.

Here, the parameter registers 31 described above may store configuration parameters corresponding to different scanning frames. The switching control module 32 described above can determine the current frame based on the count result of scanning frames counted by the counting module 33, set the parameter register group corresponding to the current frame as the target parameter register group, and read the configuration parameters from the target parameter register group to configure the LiDAR.

From the above, it can be seen that the receiving and processing apparatus provided by the embodiments of the present application can not only achieve the effects of the above embodiments, but can also set configuration parameters for different scanning frames based on detection requirements, and then during detection, determine the configuration parameters corresponding to the current frame through scanning frame counting to configure the LiDAR, enabling the LiDAR to meet different detection requirements and improving the detection performance of the LiDAR.

In one embodiment of the present application, refer again to FIG. 5. As shown in FIG. 5, the counting module 33 described above may also include a scanning column counting unit 332. The scanning column counting unit 332 may be connected to the switching control module 32 described above and is configured to count the number of scanning columns to obtain a count result of scanning columns.

In the embodiments of the present application, to meet the detection requirement of increasing point cloud density or detection distance for a target detection region, the configuration parameters of scanning columns corresponding to the target detection region may be configured as configuration parameters corresponding to increased point cloud density or increased detection distance, i.e., the configuration parameters corresponding to scanning columns of the target detection region may differ from those corresponding to scanning columns of non-target detection regions, in order to achieve increased point cloud density or detection distance for the target detection region. Therefore, the parameter register groups in the embodiments of the present application may separately include parameter register groups storing configuration parameters corresponding to the target detection region and parameter register groups storing configuration parameters corresponding to non-target detection regions.

Correspondingly, the switching control module 32 described above can determine the current scanning column based on the count result of scanning columns, and determine whether the current scanning column belongs to the target detection region. If so, the parameter register group corresponding to the target detection region is selected as the target parameter register group.

It is understood that the above is merely an example using a detection region requiring increased point cloud density or detection distance as the target detection region. The receiving and processing apparatus provided by the embodiments of the present application may also be applied to scenarios requiring reduced point cloud density or shortened detection distance, in which case the target detection region may be a detection region requiring reduced point cloud density or shortened detection distance. Similarly, different parameter register groups may be set to store configuration parameters for the target detection region and non-target detection region respectively, and then the switching control module 32 is used to determine whether the current column belongs to the target detection region and determine the corresponding parameter register group based on the result.

From the above, it can be seen that the receiving and processing apparatus provided by the embodiments of the present application can determine the detection region corresponding to the current scanning column through the count result of scanning columns, and then configure the LiDAR using the configuration parameters corresponding to the detection region, meeting different detection requirements within the detection field of view and achieving point cloud enhancement or detection distance enhancement for partial field-of-view regions.

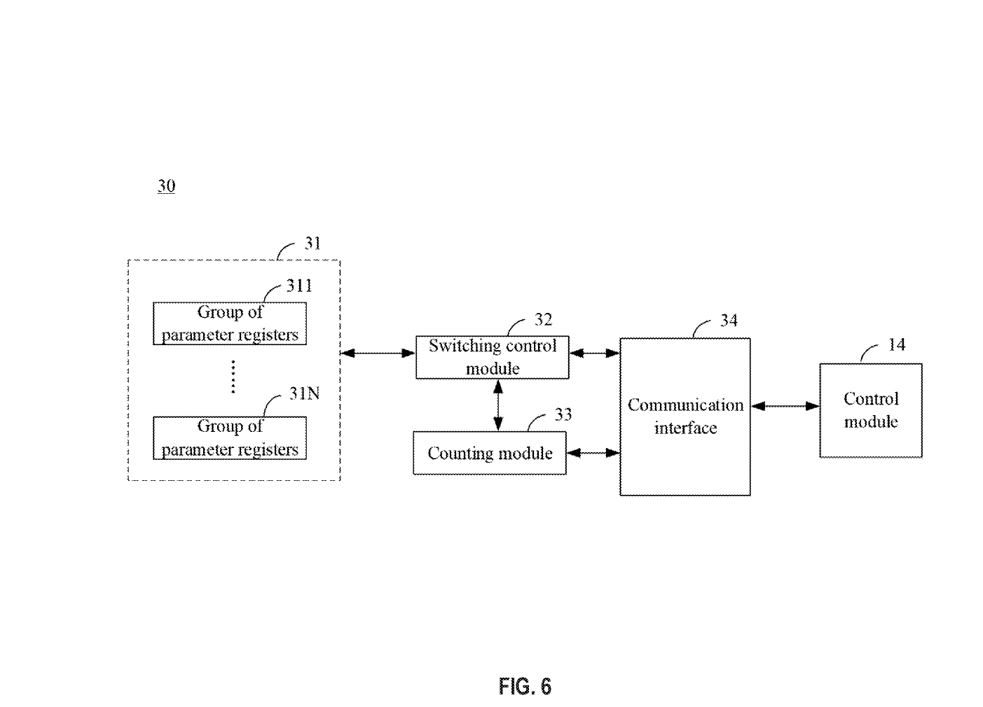

Refer to FIG. 6. In another embodiment of the present application, the receiving and processing apparatus 30 described above may also include a communication interface 34, wherein the communication interface 34 is configured to connect to the control module 14 of the radar system.

The receiving and processing module 15 described above receives the first parameter configuration instruction from the control module 14 through the communication interface 34.

In a specific application, the communication interface 34 described above may specifically be a parameter configuration interface for quickly configuring parameters, capable of transmitting the first parameter configuration instruction generated and output by the control module 14 to the switching control module 32, so that the switching control module 32 can switch the configuration parameters of the LiDAR to the configuration parameters corresponding to the first parameter configuration instruction.

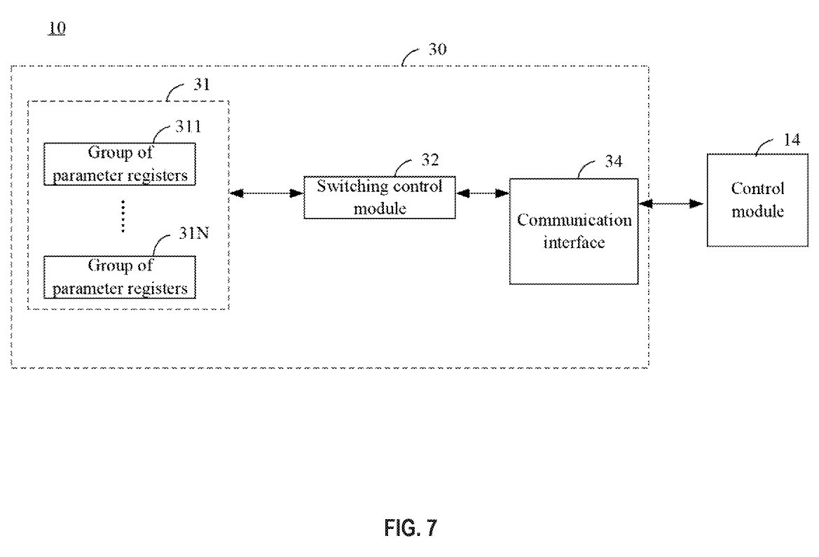

Embodiments of the present application also provide a LiDAR. Refer to FIG. 7. which shows a structural schematic diagram of another LiDAR provided by embodiments of the present application. As shown in FIG. 7, the LiDAR 10 described above may include a control module 14 and a receiving and processing apparatus 30.

The control module 14 described above can output a first parameter configuration instruction to the receiving and processing apparatus 30 based on the current scanning scenario of the LiDAR.

The receiving and processing apparatus 30 described above may include at least two groups of parameter registers 31 (e.g., 311 to 31n in FIG. 3), a switching control module 32, and a communication interface 34. The switching control module 32 is respectively connected to the parameter registers 31 and the communication interface 34. The communication interface 34 is configured to connect to the control module 14 described above.

The receiving and processing apparatus 30 receives the first parameter configuration instruction from the control module 14 through the communication interface 34; the switching control module 32 is configured to determine a target parameter register group based on the first parameter configuration instruction and to switch the configuration parameters of the radar system to the configuration parameters stored in the target parameter register group.

From the above, it can be seen that the LiDAR provided by the embodiments of the present application can achieve adaptive parameter configuration for different scanning scenarios to meet the detection requirements for different scanning scenarios.

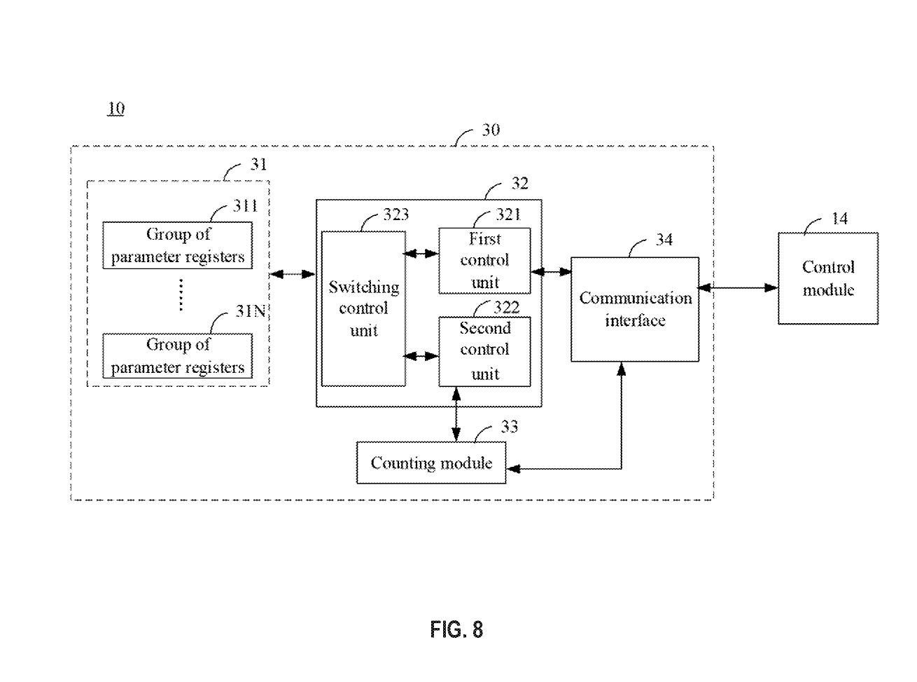

Refer to FIG. 8, which shows a structural schematic diagram of another LiDAR provided by another embodiment of the present application. As shown in FIG. 8, in the embodiments of the present application, the receiving and processing apparatus 30 further includes a counting module 33, and the switching control module 32 may include a first control unit 321, a second control unit 322, and a switching control unit 323.

The first control unit 321 is connected to the control module 14 through the communication interface 34, configured to receive the first parameter configuration instruction of the control module 14 through the communication interface 34 and to determine the target parameter register based on the first parameter configuration instruction.

The second control unit 322 is connected to the counting module 33 described above; the counting module 33 is configured to count scanning parameters; and the second control unit 322 is configured to determine the target parameter register group based on the count result of scanning parameters of the counting module 33 and the preset cyclic rule.

The details of how to determine the target parameter register group based on the count result of scanning parameters of the counting module 33 and the preset cyclic rule may be found in the relevant description in the embodiment of the receiving and processing apparatus above, and will not be repeated here.

The switching control unit 323 is respectively connected to the first control unit 321 and the second control unit 322 described above, and is configured to switch the configuration parameters of the radar system to the configuration parameters stored in the target parameter register group.

From the above, it can be seen that the LiDAR provided by the embodiments of the present application can not only perform corresponding parameter configurations based on scanning scenarios, but can also determine the current detection angle or detection region based on count results of scanning frames, scanning rows, and/or scanning columns, and then perform corresponding parameter configurations based on the detection angle or detection region, both reducing performance discrepancies caused by optical factors such as transmittance differences and meeting different detection requirements.

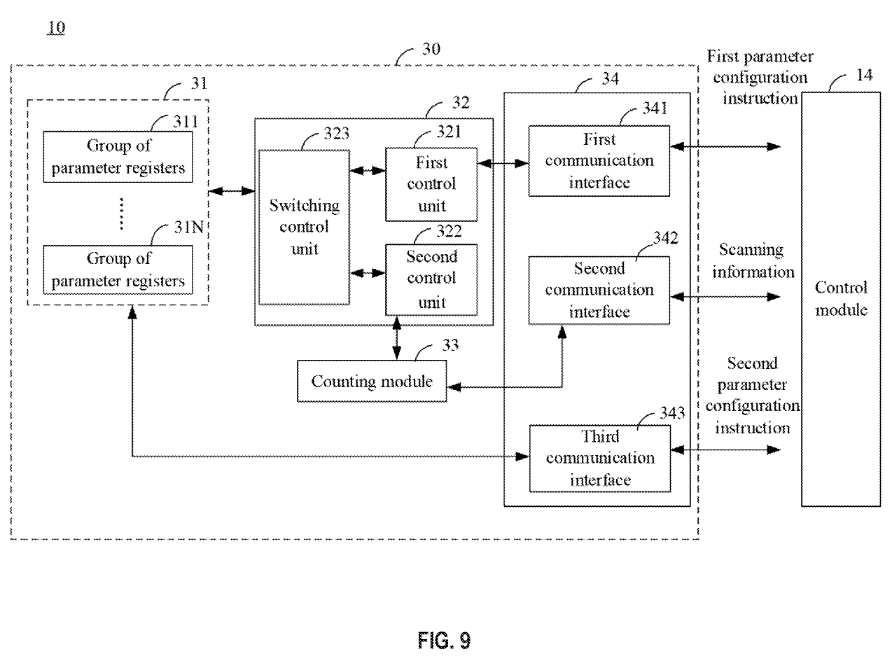

Refer to FIG. 9, which shows a structural schematic diagram of another LiDAR provided by an embodiment of the present application. As shown in FIG. 9, the communication interface 34 described above may include a first communication interface 341, a second communication interface 342, and a third communication interface 343. The first communication interface 341 is configured to receive the first parameter configuration instruction output by the control module 14; the second communication interface 342 is configured to receive scanning information output by the control module 14; the third communication interface 343 is configured to receive the second parameter configuration instruction output by the control module 14, wherein the second parameter configuration instruction is used to instruct the configuration of parameters in the parameter registers.

In a specific application, the control module 14 described above may specifically be the main control chip of the LiDAR, and the receiving and processing apparatus 30 described above may specifically be the receiving and processing chip of the LiDAR. In the case where the receiving and processing chip and the main control chip are two separate independent chips, the first communication interface 341, the second communication interface 342, and the third communication interface 343 described above may be interfaces capable of connecting to an external main control chip. In the case where the receiving and processing chip and the main control chip are designed as a single integrated chip, the first communication interface 341, the second communication interface 342, and the third communication interface 343 are actually internal interfaces of the integrated chip.

In a specific application, within the receiving and processing apparatus, there are at least two types of parameter registers. One type of parameter register can be configured via the third communication interface 343. Another type of parameter register can be configured either via the third communication interface 343 or via the first communication interface 341. Generally, for parameter registers in the receiving and processing apparatus that do not need to be switched based on scanning scenario or detection angle, configuration may be performed by the third communication interface at initial power-on. For parameter registers that require switching of configuration parameters based on scanning scenario or detection angle, configuration may be performed via the first communication interface 341.

From the above, it can be seen that the LiDAR provided by the embodiments of the present application can also perform initial configuration of parameters in the parameter registers or configure parameters based on scanning scenario/detection angle, to meet scanning requirements for different scanning scenarios and different detection angles.

The above has described in detail the receiving and processing apparatus and LiDAR provided by the embodiments of the present application. The following provides a detailed description of the LiDAR control method provided by the embodiments of the present application in conjunction with the LiDAR provided by the above embodiments:

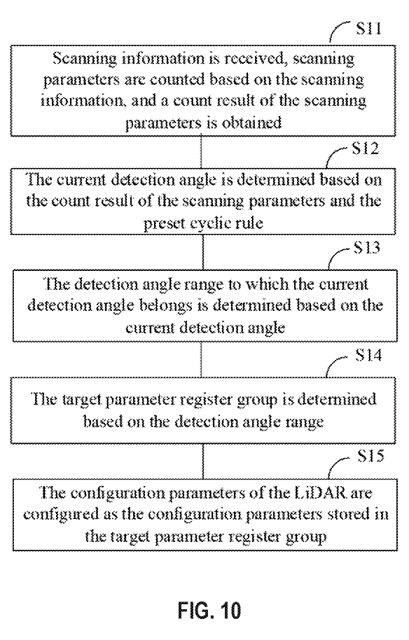

Refer to FIG. 10, which shows a schematic flow diagram of an implementation of a LiDAR control method provided by an embodiment of the present application. As shown in FIG. 10, the LiDAR control method may include the following steps.

It should be noted that the executing entity of the LiDAR control method provided by the embodiments of the present application may be the LiDAR described above, specifically the receiving and processing apparatus and control module described above. It may also be a separately provided data processing module. The present application places no specific restriction on this.

In step S11, scanning information is received, scanning parameters are counted based on the scanning information, and a count result of the scanning parameters is obtained.

In a specific application, the scanning information described above may be obtained by the control module of the LiDAR. When the control module controls the LiDAR to perform scanning, various scanning information can be obtained, such as the number of scanning rows, scanning time, number of scanning columns, and number of scanning frames, among others. When the receiving and processing apparatus receives the scanning information, it can count the scanning parameters, such as the count of scanning frames, the count of scanning rows, and the count of scanning columns, thereby obtaining corresponding count results.

In step S12, the current detection angle is determined based on the count result of the scanning parameters and the preset cyclic rule.

In step S13, the detection angle range to which the current detection angle belongs is determined based on the current detection angle.

In step S14, the target parameter register group is determined based on the detection angle range.

The details of how to determine the current detection angle based on the count result of the scanning parameters and the preset cyclic rule, how to determine the detection angle range to which the current detection angle belongs, and how to determine the target parameter register group based on the detection angle range may be found in the relevant description in the embodiment of the receiving and processing apparatus above, and will not be repeated here.

In some embodiments of the present application, after determining the count result of scanning frames, the LiDAR control method provided by the embodiments of the present application may also determine the target parameter register group corresponding to the current detection angle of the current frame based on the count result.

In some embodiments of the present application, the detection region corresponding to the current scanning column can also be determined based on the count result of scanning columns, and then the LiDAR can be configured using the configuration parameters corresponding to the detection region, meeting different detection requirements within the detection field of view and achieving point cloud enhancement or detection distance enhancement for partial field-of-view regions.

In step S15, the configuration parameters of the LiDAR are configured as the configuration parameters stored in the target parameter register group.

From the above, it can be seen that the LiDAR control method provided by the embodiments of the present application can likewise reduce performance discrepancies caused by optical factors such as transmittance differences and improve the accuracy of LiDAR detection results by configuring multiple groups of parameter registers in the receiving and processing apparatus of the LiDAR, wherein each group of parameter registers can store configuration parameters corresponding to different detection angle ranges, enabling the receiving and processing apparatus to determine the current detection angle based on preset cyclic rules and counting results of scanning parameters, and then configure the LiDAR using the configuration parameters corresponding to that detection angle.

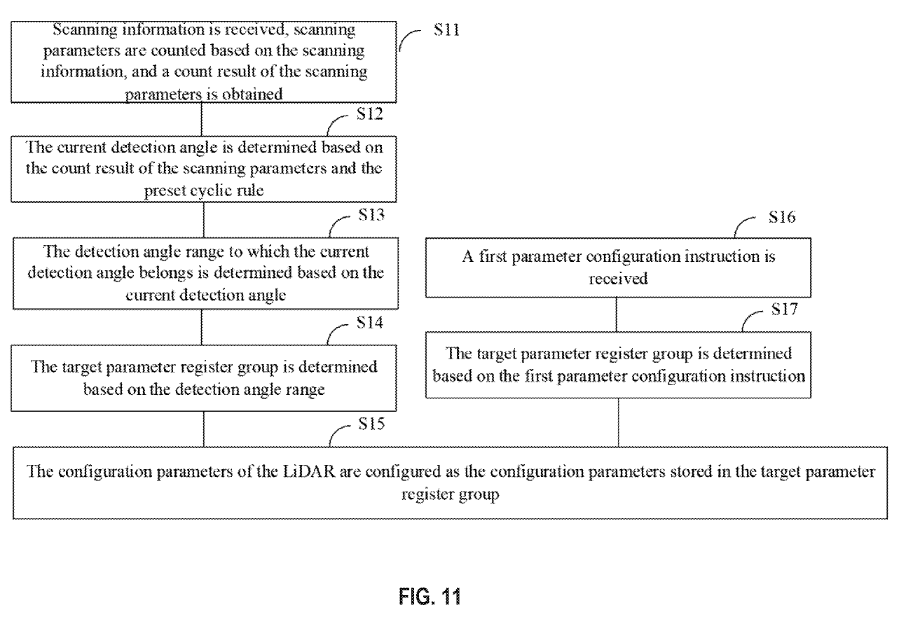

Refer to FIG. 11, which shows a schematic flow diagram of an implementation of another LiDAR control method provided by an embodiment of the present application. As shown in FIG. 11, the LiDAR control method described above further includes the following steps.

In step S16, a first parameter configuration instruction is received.

In step S17, the target parameter register group is determined based on the first parameter configuration instruction.

The details of the first parameter configuration instruction and how to determine the target parameter register group based on the first parameter configuration instruction may be found in the relevant content in the LiDAR embodiment; they will not be repeated here.

The radar control method provided by the embodiments of the present application can likewise achieve adaptive parameter configuration for different scanning scenarios to meet the detection requirements for different scanning scenarios.

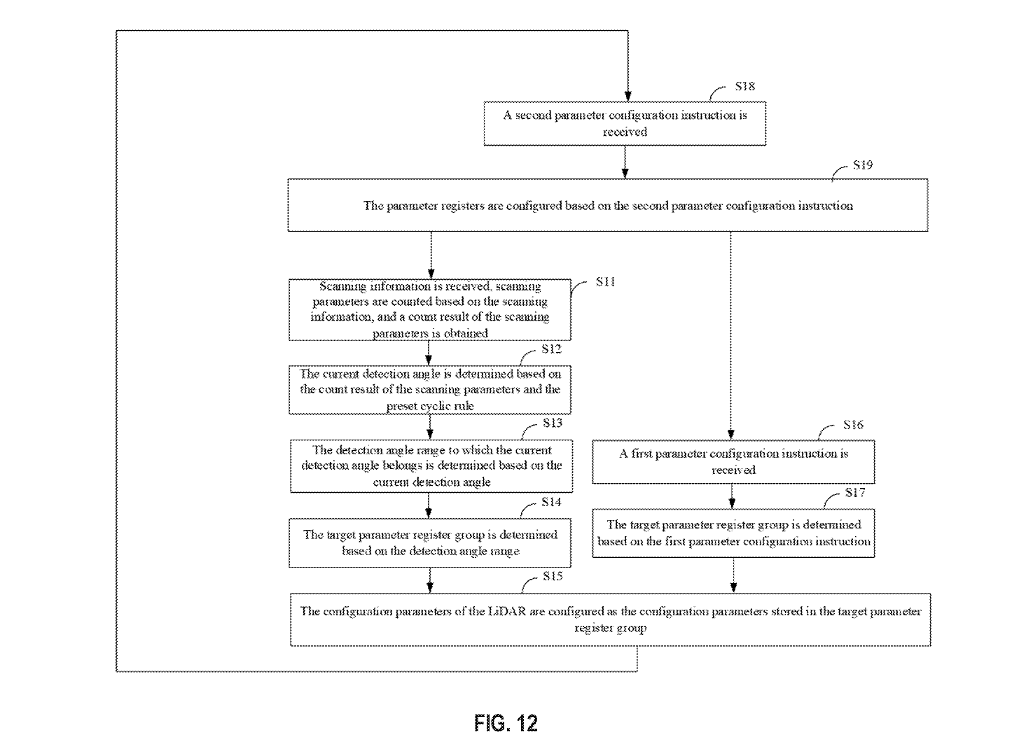

Refer to FIG. 12, which shows a schematic flow diagram of an implementation of another LiDAR control method provided by an embodiment of the present application. As shown in FIG. 12, the LiDAR control method described above further includes the following steps.

In step S18, a second parameter configuration instruction is received.

In step S19, the parameter registers are configured based on the second parameter configuration instruction.

The details of the second parameter configuration instruction and how to configure the parameter registers based on the second parameter configuration instruction may be found in the relevant content in the LiDAR embodiment; they will not be repeated here.

The radar control method provided by the embodiments of the present application can likewise perform initial configuration of parameters in the parameter registers or configure parameters based on scanning scenario/detection angle, to meet scanning requirements for different scanning scenarios and different detection angles.

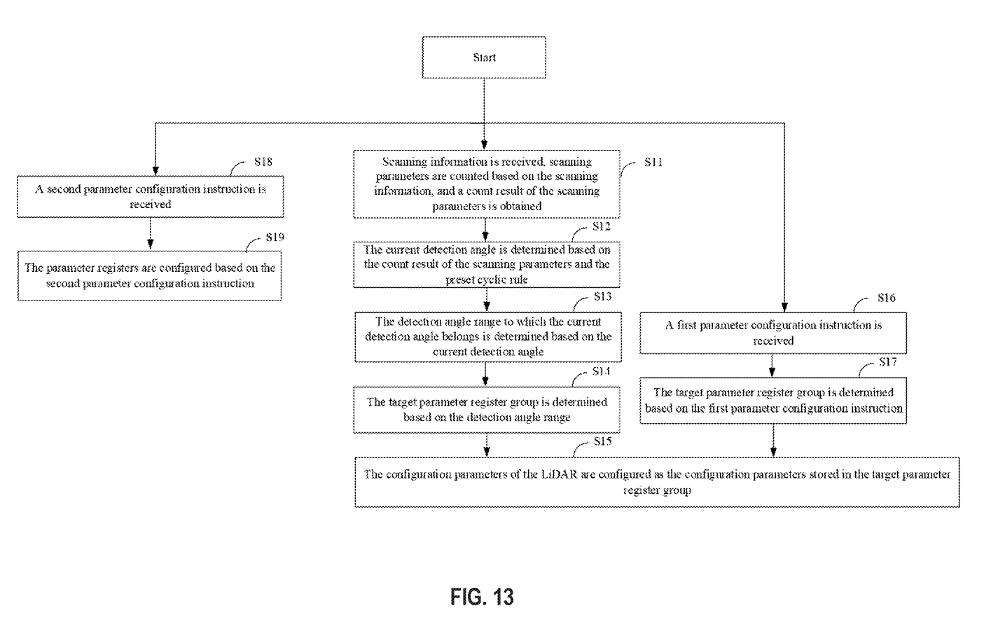

Refer to FIG. 13, which shows another LiDAR control method provided by an embodiment of the present application. Unlike the embodiment shown in FIG. 12, the second parameter configuration instruction in the embodiments of the present application may be configuration performed only after the LiDAR initialization, without being reconfigured during the LiDAR's execution of scanning tasks. In contrast, in the embodiment shown in FIG. 12, the LiDAR may change the configuration parameters stored in the parameter register groups based on actual detection conditions.

It should be understood that the sequence numbers of the steps in the above embodiments do not imply any order of execution. The execution order of the various processes should be determined by their function and internal logic and should not constitute any limitation on the implementation process of the embodiments of the present application.

Embodiments of the present application also provide a receiving and processing chip. The receiving and processing chip may include the receiving and processing apparatus of each of the above embodiments and implements the functions of the receiving and processing apparatus in each of the above embodiments.

In the embodiments of the present application, the control device may be the main control chip of the LiDAR. The receiving and processing chip and the main control chip may be two independently set chips or one integrated chip.

In the case where the receiving and processing chip and the main control chip are two separate independent chips, the first communication interface 341, the second communication interface 342, and the third communication interface 343 described above may be interfaces capable of connecting to an external main control chip. In the case where the receiving and processing chip and the main control chip are designed as a single integrated chip, the first communication interface 341, the second communication interface 342, and the third communication interface 343 are actually internal interfaces of the integrated chip.

In a specific application, within the receiving and processing chip, there are at least two types of parameter registers. One type can be configured via the third communication interface 343. Another type can be configured either via the third communication interface 343 or via the first communication interface 341. Generally, for parameter registers in the receiving and processing apparatus that do not need to be switched based on scanning scenario or detection angle, configuration may be performed by the third communication interface at initial power-on. For parameter registers that require switching of configuration parameters based on scanning scenario or detection angle, configuration may be performed via the first communication interface 341.

In some embodiments of the present application, the receiving and processing chip described above may also include a parameter configuration module that can configure parameters in the parameter registers.

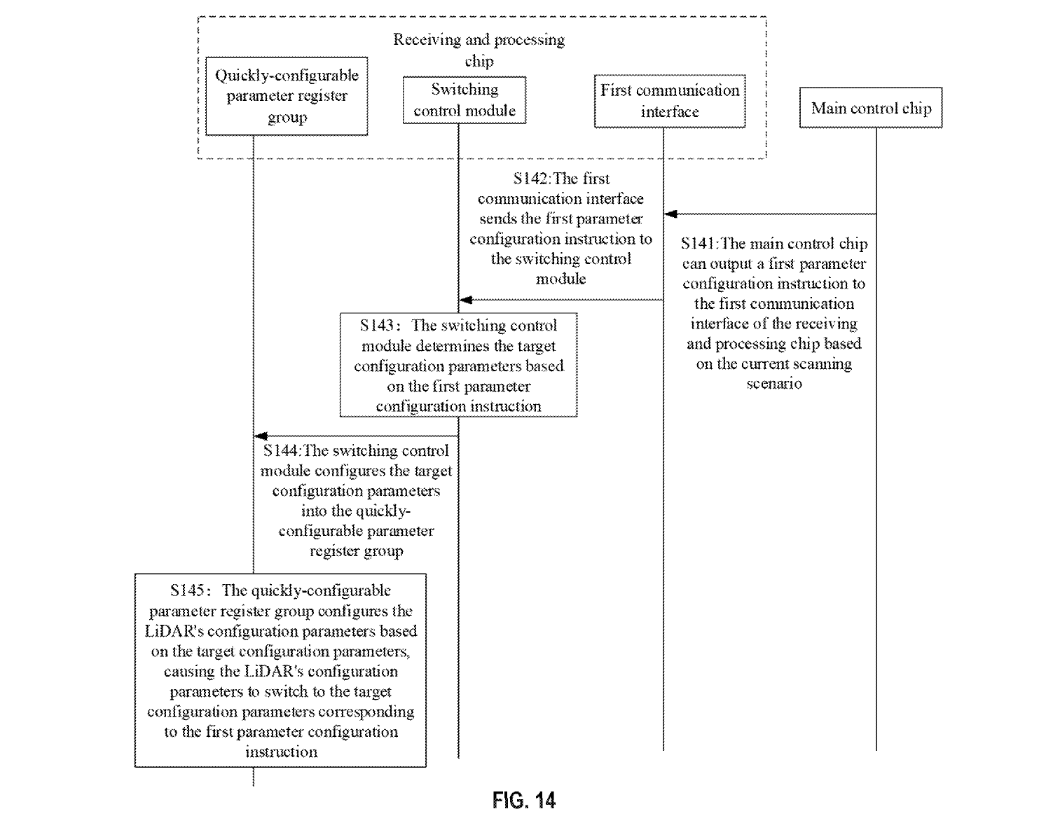

The following, in conjunction with the LiDAR shown in FIG. 9, uses the independently configured receiving and processing chip and main control chip as an example, and in conjunction with FIG. 14, provides an exemplary description of the process for configuring parameter registers that need to be switched based on scanning scenario in the receiving and processing chip.

As shown in FIG. 14, in step S141, the main control chip can output a first parameter configuration instruction to the first communication interface of the receiving and processing chip based on the current scanning scenario.

In step S142, the first communication interface sends the first parameter configuration instruction to the switching control module.

In step S143, the switching control module determines the target configuration parameters based on the first parameter configuration instruction.

In step S144, the switching control module configures the target configuration parameters into the quickly-configurable parameter register group.

In step S145, the quickly-configurable parameter register group configures the LiDAR's configuration parameters based on the target configuration parameters, causing the LiDAR's configuration parameters to switch to the target configuration parameters corresponding to the first parameter configuration instruction.

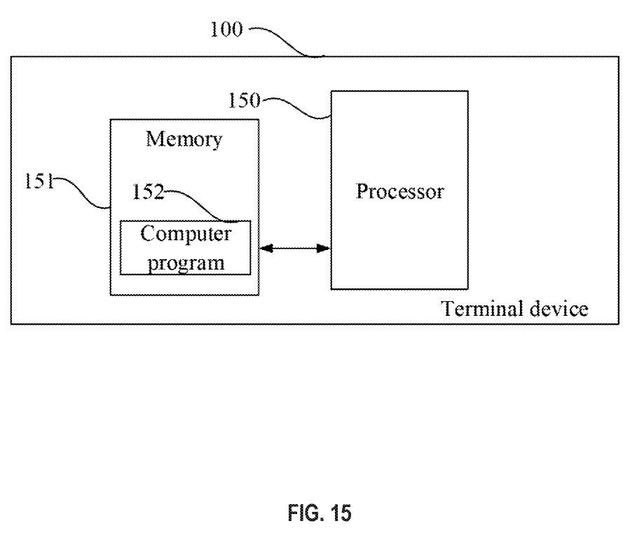

FIG. 15 is a structural schematic diagram of a terminal device provided by another embodiment of the present application. As shown in FIG. 15, the terminal device 100 of this embodiment comprises: a processor 150, a memory 151, and a computer program 152 stored in the memory 151 and executable on the processor 150. When the processor 150 executes the computer program 152, the steps of each of the above LiDAR control method embodiments are implemented, such as steps S11 to S16 shown in FIG. 10.

By way of example, the computer program 152 described above may be divided into one or more modules/units, which are stored in the memory 151 and executed by the processor 150 to complete the present application. One or more modules/units may be a series of computer program instruction segments capable of performing specific functions, which instruction segments describe the execution process of the computer program 152 in the terminal device 100.

The terminal device described above may include, but is not limited to, the processor 150 and the memory 151. Those skilled in the art will appreciate that FIG. 15 is merely an example of a terminal device and does not constitute a limitation on the terminal device; it may include more or fewer components than shown, or combine certain components, or have different components. For example, the terminal device may also include input/output devices, network access devices, buses, and so on.

The processor 150 referred to above may be a Central Processing Unit (CPU), or may be other general-purpose processors, digital signal processors (DSP), application-specific integrated circuits (ASIC), field-programmable gate arrays (FPGA), or other programmable logic devices, discrete gate or transistor logic devices, discrete hardware components, and the like. A general-purpose processor may be a microprocessor or any conventional processor.

The memory 151 described above may be an internal storage unit of the terminal device, for example, the hard disk or internal memory of the terminal device. The memory 151 may also be an external storage device of the terminal device, such as a plug-in hard disk, a Smart Media Card (SMC), a Secure Digital (SD) card, or a Flash Card configured on the terminal device. Furthermore, the memory 151 may also include both an internal storage unit and an external storage device of the terminal device. The memory 151 is configured to store the computer program and other programs and data required by the terminal device. The memory 151 may also be used to temporarily store data that has been output or is to be output.

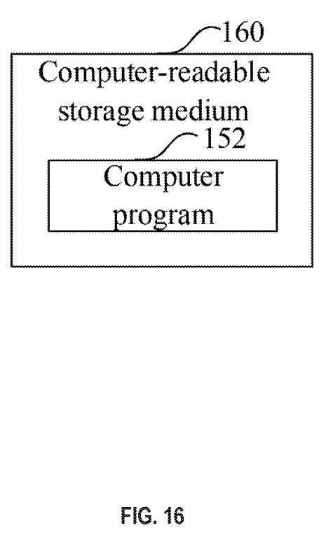

Embodiments of the present application also provide a computer-readable storage medium. Refer to FIG. 16, which is a structural schematic diagram of a computer-readable storage medium provided by an embodiment of the present application. As shown in FIG. 16, the computer-readable storage medium 160 stores a computer program 152; when executed by a processor, the computer program 152 can implement the LiDAR control method described above.

Embodiments of the present application provide a computer program product. When the computer program product runs on a terminal device, the terminal device executes and implements the LiDAR control method described above.

Embodiments of the present application also provide a radar system. The radar system includes the receiving and processing apparatus described above, and the receiving and processing apparatus may also be referred to as a receiving module.

Those skilled in the art will clearly appreciate that, for convenience and brevity of description, only the division of the above-mentioned functional units and modules is used as an illustration. In practical applications, the above-mentioned functions may be assigned to different functional units and modules as needed. The functional units and modules in the embodiments may be integrated in one processing unit, or each unit may exist physically separately, or two or more units may be integrated in one unit. The integrated units may be implemented in hardware or in the form of software functional units. In addition, the specific names of the functional units and modules are merely for the purpose of distinguishing one from another and are not intended to limit the scope of protection of the present application. For the specific working processes of the units and modules in the above system, reference may be made to the corresponding processes in the foregoing method embodiments, and they will not be described again here.

In the above embodiments, the descriptions of each embodiment have their own emphases. For parts not described in detail or recorded in one embodiment, reference may be made to the relevant descriptions in other embodiments.

Those skilled in the art will appreciate that the units and algorithm steps of the examples described in connection with the embodiments disclosed herein can be implemented in electronic hardware, or a combination of computer software and electronic hardware. Whether these functions are implemented in hardware or software depends on the specific application and design constraints of the technical solution. Those skilled in the art may use different methods to implement the described functions for each specific application, but such implementations should not be considered to exceed the scope of the present application.

In the above embodiments, the technical solutions of the present application are described, but not limited by them. Although the present application has been described in detail with reference to the foregoing embodiments, those skilled in the art should understand that they may still modify the technical solutions described in the foregoing embodiments or make equivalent substitutions for some of the technical features. Such modifications or substitutions do not cause the essence of the corresponding technical solutions to depart from the spirit and scope of the technical solutions of the embodiments of the present application, and should all be included within the scope of protection of the present application.

What is claimed is:

1. A receiving and processing apparatus, comprising:
at least two groups of parameter registers, wherein different groups of parameter registers are configured to store configuration parameters corresponding to different detection angle ranges;
a counting module, configured to count scanning parameters based on scanning information from a radar system to obtain a count result of the scanning parameters; and
a switching control module, respectively connected to the parameter registers and the counting module, configured to determine a current detection angle of a LiDAR based on the count result of the scanning parameters and a preset cyclic rule, determine a parameter register group corresponding to the detection angle range to which the current detection angle belongs as a target parameter register group, and switch the configuration parameters of the LiDAR to the configuration parameters stored in the target parameter register group; or configured to switch the configuration parameters of the LiDAR to configuration parameters corresponding to a first parameter configuration instruction based on the first parameter configuration instruction,
wherein the first parameter configuration instruction is generated by a control module based on a current application scenario of the LiDAR.

2. The receiving and processing apparatus according to claim 1, wherein the parameter register group is further configured to store configuration parameters corresponding to different scanning frames, the counting module comprises a scanning frame counting unit configured to count a number of scanning frames to obtain a count result of scanning frames; and
wherein the switching control module is further configured to determine a current frame count based on the count result of the scanning frames output by the scanning frame counting unit and the preset cyclic rule, and determine the target parameter register group based on the current frame count.

3. The receiving and processing apparatus according to claim 1, wherein
the parameter register group is further configured to store configuration parameters corresponding to a target detection region, the counting module comprises a scanning column counting unit configured to count a number of scanning columns to obtain a count result of scanning columns; and
wherein the switching control module is further configured to: if it is determined based on the count result of scanning columns that a current column is a scanning column of the target detection region, determine the parameter register group corresponding to the target detection region as the target parameter register group.

4. The receiving and processing apparatus according to claim 1, further comprising:
a communication interface, configured to connect to a control module of the LiDAR and to receive a first parameter configuration instruction output by the control module.

5. A LiDAR, comprising the receiving and processing apparatus according to claim 1, and a control module connected to the receiving and processing apparatus,
wherein the control module is configured to output a first parameter configuration instruction to the receiving and processing apparatus based on a current scanning scenario; and
wherein the receiving and processing apparatus comprises at least two groups of parameter registers, different groups of parameter registers being configured to store configuration parameters corresponding to different scanning scenarios, the receiving and processing apparatus being configured to determine a target parameter register group based on the first parameter configuration instruction and to switch the configuration parameters of the LiDAR to the configuration parameters stored in the target parameter register group.

6. The LiDAR according to claim 5, wherein
the receiving and processing apparatus comprises a communication interface, the communication interface comprises a first communication interface and a second communication interface, and the receiving and processing apparatus further comprises a counting module;
wherein the second communication interface is configured to receive scanning information output by the control module;
wherein the counting module is configured to count scanning parameters based on the scanning information and output a count result of the scanning parameters; and
wherein the receiving and processing apparatus is further configured to determine a target register group based on the count result of the scanning parameters output by the counting module and a preset cyclic rule.

7. The LiDAR according to claim 6, wherein the communication interface further comprises a third communication interface;
wherein the third communication interface is configured to receive a second parameter configuration instruction output by the control module; and
wherein the receiving and processing apparatus is further configured to configure the parameter registers based on the second parameter configuration instruction.

8. A control method for a LiDAR, applied to a receiving and processing apparatus, wherein the receiving and processing apparatus comprises at least two groups of parameter registers, different groups of parameter registers storing configuration parameters corresponding to different detection angle ranges, the control method comprising:
receiving scanning information and counting scanning parameters based on the scanning information to obtain a count result of the scanning parameters;
determining a current detection angle based on the count result of the scanning parameters and a preset cyclic rule;
determining the detection angle range to which the current detection angle belongs based on the current detection angle;
determining a target parameter register group based on the detection angle range; and
configuring configuration parameters of the LiDAR as the configuration parameters stored in the target parameter register group.

9. The control method according to claim 8, further comprising:
receiving a first parameter configuration instruction; and
determining the target parameter register group based on the first parameter configuration instruction.

10. The control method according to claim 8, further comprising:
receiving a second parameter configuration instruction; and
configuring the parameter registers based on the second parameter configuration instruction.
